(19) United States
(12) Patent Application Publication
(10) Pub. No.: US 2024/0213580 A1
(43) Pub. Date: Jun. 27, 2024

(54) FLEXIBLE, HEAT-CONDUCTING, INSULATING, AND VISCOUS PHASE CHANGE HEAT DISSIPATION SHEET, AND PREPARATION METHOD THEREFOR AND BATTERY THERMAL MANAGEMENT SYSTEM THEREOF

(71) Applicant: SOUTH CHINA UNIVERSITY OF TECHNOLOGY, Guangzhou (CN)

(72) Inventors: Zhengguo ZHANG, Guangzhou (CN); Yi WU, Guangzhou (CN); Ziye LING, Guangzhou (CN); Xiaoming FANG, Guangzhou (CN)

(73) Assignee: SOUTH CHINA UNIVERSITY OF TECHNOLOGY, Guangzhou (CN)

(21) Appl. No.: 18/557,289

(22) PCT Filed: Oct. 31, 2021
(86) PCT No.: PCT/CN2021/127800

§ 371 Date: Jan. 29, 2024

(30) Foreign Application Priority Data
Apr. 25, 2021 (CN) 202110447141.8

(51) Int. Cl. H01M 10/659; H01M 10/617; H01M 10/651; H01M 10/6554

(52) U.S. Cl. CPC H01M 10/659; H01M 10/617; H01M 10/651; H01M 10/6554

(57) ABSTRACT

The present invention is related to a flexible, heat-conducting, insulating, and viscous phase change heat dissipation sheet, and a preparation method therefor and a battery thermal management system thereof. The phase change heat dissipation sheet comprises the following components in percentage by mass: 65-75% of paraffin, 10-20% of polystyrene-polyethylene-polybutylene-polystyrene, 10-20% of boron nitride, and 1-3% of polyvinyl alcohol. The present invention uses an elastic plastic to provide a flexible support substrate for a phase change material, and uses the elliptic/circular laminated sheet-shaped boron nitride as a heat-conducting filler, so that a finally prepared composite material has excellent heat-conducting property and electrical insulation property. Moreover, the prepared thin sheet has flexibility, and can be widely applied to the thermal management of lithium batteries having different shapes, such as cylindrical batteries, cuboid hard-shell batteries, and pouch batteries. The present invention is simple in preparation method and convenient to use.

### BACKGROUND OF THE INVENTION

### Technical Field

The present invention relates to the field of preparation and use of high-thermal-conductivity composite phase change materials and particularly relates to a flexible, heat-conducting, insulating, and viscous phase change heat dissipation sheet, a preparation method therefor and a battery thermal management system thereof.

### Background Art

Lithium batteries are widely used in digital products and electric vehicle power systems. However, a large amount of heat is generated during the operation of the lithium battery, which causes an increase in the temperature of the battery, resulting in a decrease in the performance and safety of the battery. Lithium batteries therefore require thermal management to control their temperature to be within the optimal operating range of 20-55° C., and the inter-battery temperature difference to be less than 5° C.

The phase change material is a material capable of absorbing a large amount of heat during a solid-liquid phase change and maintaining a constant temperature and thus can be used to absorb the heat of the battery and control the temperature of the battery. However, a general phase change material changes from a solid phase to a liquid phase, has fluidity and is extremely inconvenient to use. Moreover, the phase change material generally has a low thermal conductivity of about 0.2-0.6 W/m·K, has a poor heat dissipation effect during use, and has a high battery temperature and temperature difference between the batteries.

Therefore, preparing a high-thermal-conductivity set-shaped composite phase change material, increasing the thermal conductivity of the phase change material, and overcoming the liquid phase flow generated by the solid-liquid phase change process of the phase change material can improve the ease of use of the phase change material.

At present, the preparation of high-thermal-conductivity set-shaped composite phase change materials is mainly obtained by adsorption of phase change materials such as paraffin wax to high thermal conductivity porous media such as expanded graphite, but the expanded graphite is a powder material. Although the prepared set-shaped composite phase change materials do not have liquid phase leakage and have high thermal conductivity, the composite phase change materials are easily broken when impacted.

Compounding phase change materials with polymer matrix is another main method for preparing set-shaped composite phase change materials. Compared with expanded graphite and other powder materials, the set-shaped materials prepared with polymer matrix also have no liquid leakage problem, and have good mechanical properties, which can give them good flexibility or elasticity. CN201910951534.5 discloses a method for preparing a paraffin-SEBS thermoplastic elastomer composite phase change material, and the flexible composite phase change material prepared by the method has a strong adsorption capacity and a large phase change enthalpy value.

However, polymer-based composite phase change materials have low thermal conductivity and poor heat dissipation performance when used in the batteries. In order to improve the thermal conductivity of a polymer matrix composite phase change material, CN111607362 A and CN110137626 A disclose that two flexible high thermal conductivity phase change materials are applied to battery thermal management; however, in order to improve the thermal conductivity of the composite phase change material, the thermal conductive fillers added in the two methods are both materials with conductive properties, such as expanded graphite, so that the phase change material are not insulating, and the application of a phase change heat dissipation sheet to battery thermal management would increase the risk of battery short circuit.

Moreover, existing phase change material thermal management structures require first preparing a block of phase change material, then leaving the battery hole site by drilling or the like, and then inserting the battery into the hole. Not only the operation is complicated, but also the phase change material is not in complete contact with the battery, only at the surface, there is no force between the two, and the two cannot be closely fitted. The battery and phase change material may lose contact due to thermal stress such as expansion and contraction, or impact of vibration, so that the heat cannot be transferred in time, resulting in the degradation of performance of the heat dissipation sheet.

Therefore, the development of a set-shaped composite phase change material based on a polymer matrix is beneficial to the application of the phase change material in the heat dissipation of a battery, but in order to solve the problems of the set-shaped composite phase change material based on a polymer matrix, it is necessary to endow it with a high thermal conductivity under the premise of ensuring its insulation, and at the same time, increase the viscosity of the material on the surface, so as to make it better fit with the battery.

### SUMMARY OF THE INVENTION

### Technical Problem

### Solution to the Problem

### Technical Solution

The present invention provides a preparation method for a viscous composite phase change heat dissipation sheet having flexibility and excellent thermal conductivity and electrical insulation properties, in order to overcome the problems of liquid leakage, poor thermal conductivity, and poor battery adhesion of conventional phase change materials. A flexible, high heat-conducting, insulating, and viscous phase change heat dissipation sheet and a battery thermal management system thereof are also provided.

The composite phase change material heat dissipation sheet of the present invention has the following features: paraffin wax is used as a phase change material substrate, and the phase change temperature is 30-55° C., being high heat-conducting, insulating, flexible and viscous, simultaneously. The thermal conductivity is higher than 2.5 W/m·K and the electrical resistivity is higher than 18000 Ω·m. When the temperature is lower than the phase change temperature, the Shore hardness is 80 HA, and when the temperature is higher than the phase change temperature, the Shore hardness is less than 15 HA. The composite phase change material has a phase change enthalpy higher than 150 KJ/kg, and a density of 850-950 kg/m³.

The object of the present invention is achieved by the following technical solutions:

A flexible, heat-conducting, insulating, and viscous phase change heat dissipation sheet comprises the following components in percentage by mass: 65-75% of paraffin, 10-20% of polystyrene-polyethylene-polybutylene-polystyrene, 10-20% of boron nitride, and 1-3% of polyvinyl alcohol.

Preferably, the phase change heat dissipation sheet has a thermal conductivity greater than 2.5 W/m·K, an electrical resistivity greater than 18000 Ω·m, and a Shore hardness less than 15 HA when the temperature is above a phase change temperature of the phase change heat dissipation sheet.

Preferably, the phase change heat dissipation sheet has a phase change temperature of 30-55° C., a phase change enthalpy more than 150 KJ/kg, and a density of 850-950 kg/m³.

Preferably, the boron nitride has an average particle size of 5-10 μm and has a circular and elliptic laminated sheet-shaped structure obtained by plasma ball milling. The morphology and size of the thermally conductive filler, boron nitride, in the present invention have a great influence on the thermal conductivity of the composite material, and therefore it is necessary to perform plasma ball milling to allow the boron nitride to have a circular and elliptic laminated sheet-shaped structure with an average particle size of 5-10 μm. In addition, content of BN needs to be strictly controlled. Too low or too high content of the thermal conductive filler may fails to form a thermal conductive network, and the improvement effect of thermal conductivity coefficient is not good, while too high content of thermal conductive filler may lead to the collapse of thermal elastomer network.

Preferably, the thickness of the phase change heat dissipation sheet is 2-4 mm.

The above preparation method for the flexible, heat-conducting, insulating, and viscous phase change heat dissipation sheet comprises the following steps:

(1) material melt mixing: first mixing the polystyrene-polyethylene-polybutylene-polystyrene with the boron nitride, and then adding the melted paraffin liquid for stirring to obtain a mixture material:

(2) hot-pressing into blocks: preheating the mixture material obtained in step (1) at a temperature of 130-135° C., and hot-pressing at a pressure of 10-14 MPa to obtain blocks;
(3) viscous substrate coating: applying the polyvinyl alcohol solution to the surface of the blocks obtained in step (2).

Preferably, the paraffin liquid in step (1) is prepared by melting the paraffin in an oven at a temperature of 20-30° C. higher than the melting point thereof.

Preferably, temperature of the stirring in step (1) is 70-90° C., and time for the stirring is

0.5-1.5 h.

Preferably, time for the hot-pressing of step (2) is 10-15 min, and time for the preheating is 1-3 min.

Preferably, the coating of step (3) is a mechanical coating.

In the battery thermal management system of the above-mentioned flexible, heat-conducting, insulating, and viscous phase change heat dissipation sheet, the phase change heat dissipation sheet is directly attached to the surface of a single or a plurality of batteries in the shape of cylindrical, cuboid hard-shell or pouch batteries.

### Advantageous Effects of the Invention

### Advantageous Effects

The flexible, heat-conducting, insulating, and viscous phase change heat dissipation sheet prepared by the method of the present invention has the following advantages:

(1) It has the characteristics of high heat conduction, insulation, flexibility, and viscosity, simultaneously, and can be applied to the thermal management of power batteries and digital batteries:

(2) It is flexible, freely deformable, has good adhesion, and can be closely adhered to the surface of any shape of batteries, including cylindrical batteries, cuboid batteries, or pouch batteries, so as to achieve the purpose of battery heat dissipation. The adhesion process is simple and convenient, and it does not need to prepare a phase change material block in advance and then perform mechanical processing to provide a hole site for a battery, which is conducive to the rapid assembly of a battery module;

(3) Compared with the conventional polymer matrix composite phase change materials, the present material has higher thermal conductivity, and can effectively reduce the temperature rise and temperature difference in the process of battery operation when applied in battery thermal management.

Compared with the phase change material compounded with a polymer substrate and prepared with an electrically conductive and thermally conductive reinforcing agent such as graphite, the present material uses boron nitride as an insulating and thermally conductive filler with special morphology to construct a thermally conductive network, which not only has high thermal conductivity, but also has a high electrical resistivity and a good insulating property, and the heat dissipation sheet will not short-circuit even in contact with a battery electrode during use.

### BRIEF DESCRIPTION OF THE DRAWINGS

### Description of the Drawings

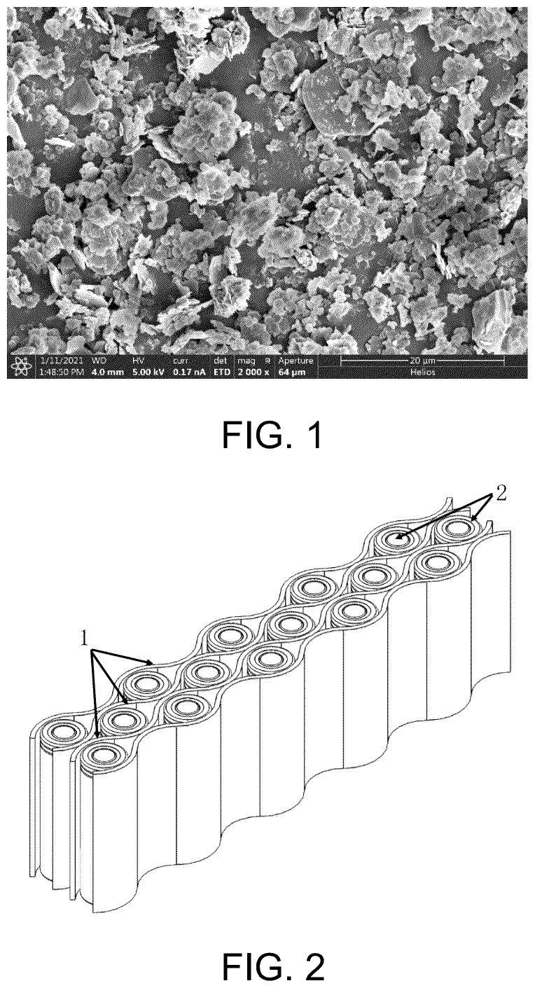

FIG. 1 is a boron nitride morphology control structure diagram;

FIG. 2 is a schematic diagram showing a heat dissipation structure of the flexible, high heat-conducting, insulating, and viscous phase change heat dissipation sheet of Example 1 applied to cylindrical batteries;

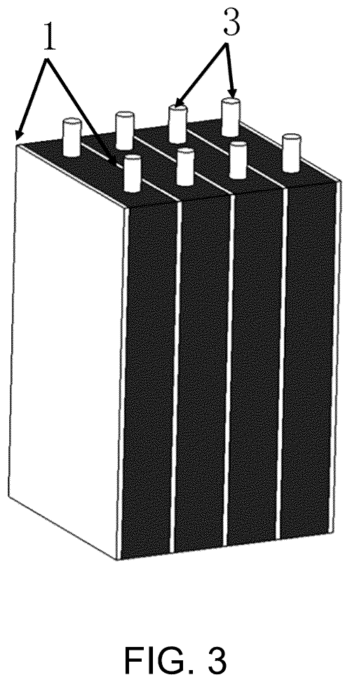

FIG. 3 is a schematic diagram showing a heat dissipation structure of the flexible, high heat-conducting, insulating, and viscous phase change heat dissipation sheet of Example 2 applied to cuboid batteries.

### DETAILED DESCRIPTION OF THE EMBODIMENTS

### Mode of the Present Invention

Hereinafter, embodiments of the present invention will be described in detail with reference to the accompanying drawings. In the present invention, all the equipment and raw materials are commercially available or commonly used in the art unless otherwise specified, and the processes in the following examples, unless otherwise specified, are conventional in the art.

In order that those skilled in the art may better understand the teachings of the present application, a further detailed description of the below in connection with the accompanying drawings and detailed description. It is to be understood that the described embodiments are only a partial embodiment of the present application and not all embodiments. Based on the embodiments in the present application, all the other embodiments obtained by a person of ordinary skill in the art without involving any inventive effort fall within the scope of protection of the present application.

In the following description, numerous specific details are set forth in order to provide a thorough understanding of the present invention, but the present invention may be practiced otherwise than as specifically described herein, and it will be apparent to those skilled in the art that the present invention may be practiced otherwise than as specifically described without departing from the spirit of the invention. Accordingly, the present invention is not limited by the specific embodiments disclosed below.

The steps for preparing a flexible, high heat-conducting, insulating, and viscous phase change heat dissipation sheet of the present invention are as follows:

Preparation of mixture material: the paraffin wax was melted in an oven at a temperature of 20° ° C. above its melting point. 10-20% by mass fraction of SEBS (polystyrene-polyethylene-polybutylene-polystyrene) and 10-20% by mass fraction of boron nitride was placed in a beaker, and stirred until uniform, then 65-75% by mass fraction of paraffin liquid was added and mixed well. The mixture was heated in an oven at 70° C. for melt adsorption and stirred periodically for 1 h to obtain a mixture material. The mixture was stored in an oven at 60-70° C. for later use.

Hot-pressing into blocks: the mixed material was introduced into a molding die at normal temperature and preheated in a curing press at a temperature of 130-135° C. for 2 min under non-pressure conditions. Then hot-pressing was performed at a pressure of 10-14 MPa for 10 min, then the pressure was released, and a flexible high-thermal-conductivity insulating phase change sheet with a thickness of 2-4 mm and a density of 850-950 kg/m³ was taken out.

Viscous substrate coating: by using a mechanical coating device, a 1-3% PVA (polyvinyl alcohol) solution is uniformly coated on the surface of the phase change material.

The above-mentioned boron nitride was subjected to plasma ball milling to a circular and elliptic laminated sheet-shaped structure with an average particle size of 5-10 μm. The resulting boron nitride particle morphology control structure is shown in FIG. 1.

### EXAMPLE 1

A composite phase change heat dissipation sheet with a density of 950 kg/m³ was prepared as described above from by mass fraction of 65% paraffin wax with a melting point of 44° C., 17.5% SEBS, 15% boron nitride, and 2.5% PVA solution.

The phase change material had a phase change enthalpy of 156 KJ/kg, a thermal conductivity of 3.0 W/m·K, and an electrical resistivity of 20085 Ω·m.

Three pieces of 2 mm thick phase change heat dissipation sheet 1 are attached to the surfaces of 15 cylindrical batteries 2 in a serpentine shape as shown in FIG. 2.

The battery was discharged at a 1C rate in a 25° C. environment, and the maximum temperature of the battery was reduced by 5.2° C., and the maximum temperature difference between the batteries was reduced by 3.1° C., compared with the battery module without the phase change material.

### EXAMPLE 2

A composite phase change heat dissipation sheet with a density of 950 kg/m³ was prepared as described above from by mass fraction of 70% paraffin wax with a melting point of 52° C. 17.5% SEBS, 10% boron nitride, and 2.5% PVA solution.

The phase change material had a phase change enthalpy of 168 KJ/kg, a thermal conductivity of 2.5 W/m·K. and an electrical resistivity of 18586 Ω·m.

Four pieces of rectangular phase change heat dissipation sheets 1 with a thickness of 4 mm were attached to the surfaces of three cuboid hard-shell batteries 3 as shown in FIG. 3.

When the battery was discharged at a rate of 2C in a 25° C. environment, the maximum temperature of the battery was reduced by 10.2° C., and the maximum temperature difference between the batteries was reduced by 2.6° C., compared with the battery module without the phase change material.

### EXAMPLE 3

A composite phase change heat dissipation sheet with a density of 950 kg/m³ was prepared as described above from by mass fraction of 65% paraffin wax with a melting point of 44° C., 27.5% SEBS, 5% boron nitride, and 2.5% PVA solution.

### EXAMPLE 4

A composite phase change heat dissipation sheet with a density of 950 kg/m³ was prepared as described above from by mass fraction of 65% paraffin wax with a melting point of 44° C., 22.5% SEBS, 10% boron nitride, and 2.5% PVA solution.

### EXAMPLE 5

A composite phase change heat dissipation sheet with a density of 950 kg/m³ was prepared as described above from by mass fraction of 65% paraffin wax with a melting point of 44° C. 12.5% SEBS, 20% boron nitride, and 2.5% PVA solution.

### EXAMPLE 6

A composite phase change heat dissipation sheet with a density of 950 kg/m³ was prepared as described above from by mass fraction of 65% paraffin wax with a melting point of 44° C., 7.5% SEBS, 25% boron nitride, and 2.5% PVA solution.

### EXAMPLE 7

A composite phase change heat dissipation sheet with a density of 950 kg/m³ was prepared as described above from by mass fraction of 65% paraffin wax with a melting point of 44° C., 32.5% SEBS, and 2.5% PVA a solution.

The raw material ratios of the composite phase change heat dissipation sheet prepared in Examples 1, 3-7 are shown in Table 1 to further demonstrate the effect of boron nitride content on performance.

TABLE 1

| | Content of | | Content of | |
|---|---|---|---|---|
| | phase change | Content of | boron nitride | Content of |
| No. | material (%) | SEBS (%) | (%) | PVA (%) |
| Example 7 | 65 | 32.5 | 0 | 2.5 |
| Example 3 | 65 | 27.5 | 5 | 2.5 |
| Example 4 | 65 | 22.5 | 10 | 2.5 |
| Example 1 | 65 | 17.5 | 15 | 2.5 |
| Example 5 | 65 | 12.5 | 20 | 2.5 |
| Example 6 | 65 | 7.5 | 25 | 2.5 |

It is found that when the content of boron nitride is 5%, the thermal conductivity of the composite phase change sheet is only 1.0 W/m·K, and the thermal conductivity is insufficient. When the content of boron nitride is 25%, many cracks are generated on the surface of the phase change sheet and are easily broken, so that a smooth surface cannot be formed and it is difficult to use. When the content of boron nitride is between 10% and 20%, the thermal conductivity of the phase change material is 2-3 W/m·K, and the phase change material has a completely smooth plane.

The phase change sheets prepared above were applied to the cylindrical batteries for heat dissipation. When the discharge rate of the battery was 1.5C, the addition of phase change sheets with boron nitride contents of 10, 15, and 20% reduced the temperature rise of the battery by 0.5/0.8/1.2° C. and the temperature difference between the batteries by 1.5/2.3/2.7° C., respectively, compared with the phase change sheet without boron nitride.

The phase change sheets prepared above were applied to the cuboid battery for heat dissipation. When the battery discharge rate was 6C, the addition of phase change sheets with boron nitride contents of 10%, 15%, and 20% reduced the temperature rise of the battery by 4.5/5.8/6.7° C. and the temperature difference between the batteries by 2.1/2.6/3.3° C., respectively, compared with the phase change sheets without boron nitride.

While the foregoing is directed to embodiments of the present invention, other and further embodiments of the invention may be devised without departing from the basic scope thereof, and the scope thereof is determined by the claims that follow.

1. A flexible, heat-conducting, insulating, and viscous phase change heat dissipation sheet, comprising the following components in percentage by mass: 65-75% of paraffin, 10-20% of polystyrene-polyethylene-polybutylene-polystyrene, 10-20% of boron nitride, and 1-3% of polyvinyl alcohol.

2. The flexible, heat-conducting, insulating, and viscous phase change heat dissipation sheet of claim 1, wherein the phase change heat dissipation sheet has a thermal conductivity greater than 2.5 W/m·K, an electrical resistivity greater than 18000 Ω·m, and a Shore hardness less than 15 HA when the temperature is above a phase change temperature of the phase change heat dissipation sheet.

3. The flexible, heat-conducting, insulating, and viscous phase change heat dissipation sheet of claim 1, wherein the phase change heat dissipation sheet has a phase change temperature of 30-55° C., a phase change enthalpy greater than 150 KJ/kg, and a density of 850-950 kg/m³.

4. The flexible, heat-conducting, insulating, and viscous phase change heat dissipation sheet of claim 1, wherein the boron nitride has an average particle size of 5-10 μm, and has a circular and elliptic laminated sheet-shaped structure obtained by plasma ball milling.

5. The flexible, heat-conducting, insulating, and viscous phase change heat dissipation sheet of claim 1, wherein the phase change heat dissipation sheet has a thickness of 2 to 4 mm.

6. A preparation method of the flexible, heat-conducting, insulating, and viscous phase change heat dissipation sheet of claim 1, comprising steps of:
(1) material melt mixing: first mixing the polystyrene-polyethylene-polybutylene-polystyrene with the boron nitride, and then adding a melted paraffin liquid for stirring to obtain a mixture material;
(2) hot-pressing into blocks: preheating the mixture material obtained in the step (1) at a temperature of 130-135° C., and hot-pressing at a pressure of 10-14 MPa to obtain the blocks;
(3) viscous substrate coating: applying a polyvinyl alcohol solution to a surface of the blocks obtained in the step (2).

7. The preparation method of claim 6, characterized in that, the paraffin liquid in the step (1) is prepared by melting a paraffin in an oven at a temperature of 20-30° C. higher than a melting point of the paraffin.

8. The preparation method of claim 6, characterized in that, a temperature for the stirring in the step (1) is 70-90° C., and a time for the stirring is 0.5-1.5 h.

9. The preparation method of claim 6, characterized in that, a time for the hot-pressing of the step (2) is 10-15 min, and a time for the preheating is 1-3 min.

10. A battery thermal management system based on the flexible, heat-conducting, insulating, and viscous phase change heat dissipation sheet of claim 1, wherein the phase change heat dissipation sheet is directly attached to a surface of a single battery or a plurality of batteries in a shape of a cylindrical, a cuboid hard-shell or a pouch battery.
